(19) United States
(12) Patent Application Publication
(10) Pub. No.: US 2016/0055148 A1
(43) Pub. Date: Feb. 25, 2016

(54) TranslateMe - Software Application to Translate Message(s)/Picture(s) through Human Collaboration

(71) Applicant: Shanthakumari Raju, Phoenix, AZ (US)

(72) Inventor: Shanthakumari Raju, Phoenix, AZ (US)

(73) Assignee: Mr. Ravi Kumar Govindan, Phoenix, AZ (US)

(21) Appl. No.: 14/465,834

(22) Filed: Aug. 22, 2014

(51) Int. Cl. G06F 17/28

(52) U.S. Cl. CPC G06F 17/289

(57) ABSTRACT

TranslateMe is an Application to help a User get the Translation of a message(word or sentences)/picture(s) by sending it to a particular Language Group(s) that the User intends to get translation for. The User seeking to get the message/picture translated sends it to that intended Language Group Users who are proficient in that Language and receives the translated response instantly. The message/picture Translation is purely done by interaction/collaboration with humans using this application. This application is not limited to any specific language, computer device. It can be used to various widely spoken languages all around the world and would be developed for desktop, mobile, tablet and other portable devices.

This application would be very useful for travelers, language enthusiasts, students, researchers etc. This is neither intended as a Foreign Language learning Application nor like Facebook/Personal Group Collaboration, where the Users Status or Pictures are shared to a group of known Friends and get their comments. Instead by using this application if I want to translate a word or sentence in a Language that I am not proficient with, then I can send that message to that Language Proficient Group and receive the Translation.

### BACKGROUND

An Application to help a User get the Translation of a message(word or sentences)/picture(s) by sending it to a particular Language Group(s) that the User intends to get translation for. User sends messages/pictures to other Language Group Users who are proficient in that Language and receives/gets Instant Translation for their messages/pictures sent. The message/picture Translation is purely done by interaction/collaboration with humans using this application.

In this Application, a User sends the message/picture that they intend to translate to a Language Group and NOT to a particular person. After sending their message/picture, the User waits for someone from that Language Speaking Group to respond with the Translation.

By exchanging the Translated Message, a User can now get translation from people who speak that language which would be more accurate and precise than the existing translators that are translated by non-humans (machines).

In order to help others to translate their messages/pictures an User has to register to the Language Groups that they are Proficient with, whereas if a User is in need to get the Translation of a Message/picture he/she need not register to any Language Group, but can send their messages/pictures to that Particular Language Proficient Group.

This application is not limited to any specific language, computer device. It can be scalable to various widely spoken languages all around the world and would be developed for desktop, mobile, tablet and other portable devices.

### DIAGRAMS

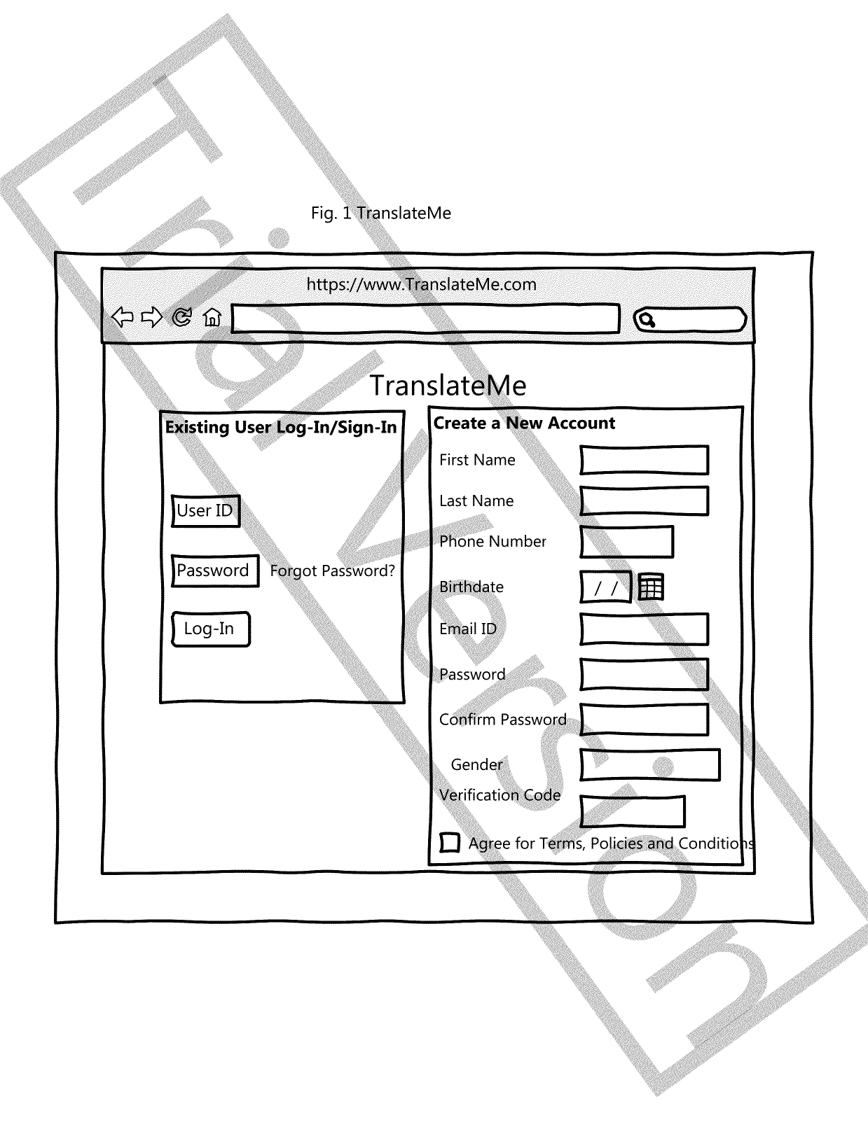

FIG. 1—Is the Login Screen where the User Signs up for a new account in TranslateMe with their Profile information and once the account is created, the User successfully Logins in to TranslateMe by providing an active User ID and Password.

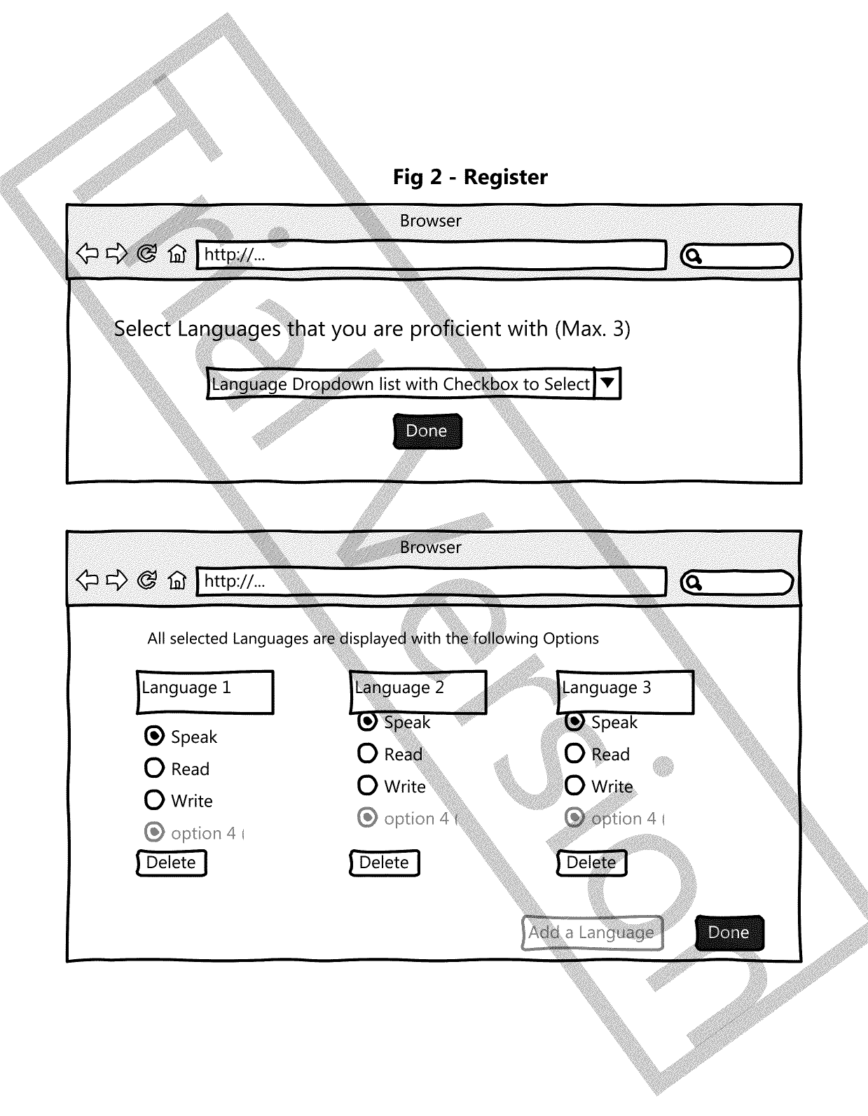

FIG. 2—Register: The User selects maximum of 3 languages that he/she is proficient with and registers for that Language Group. By doing this the User can help others who had submitted words to get it translated in that Language Group. The Proficient Language that they have selected appears on their left and the previous posts that the User has send is also listed as in the Fig. to keep track of the responses.

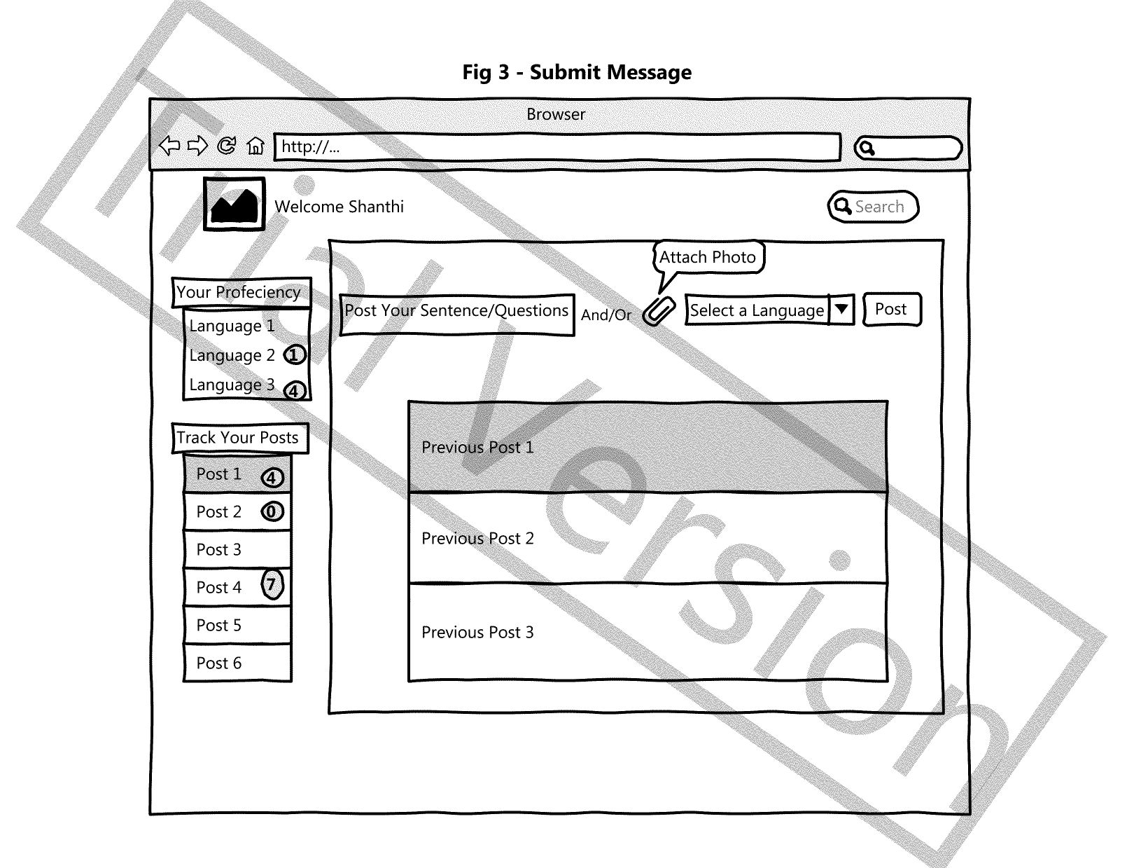

FIG. 3—Submit Message: An Registered or Unregistered User can submit their Message/picture to that Particular Language Group that they want the message to be translated in that Language.

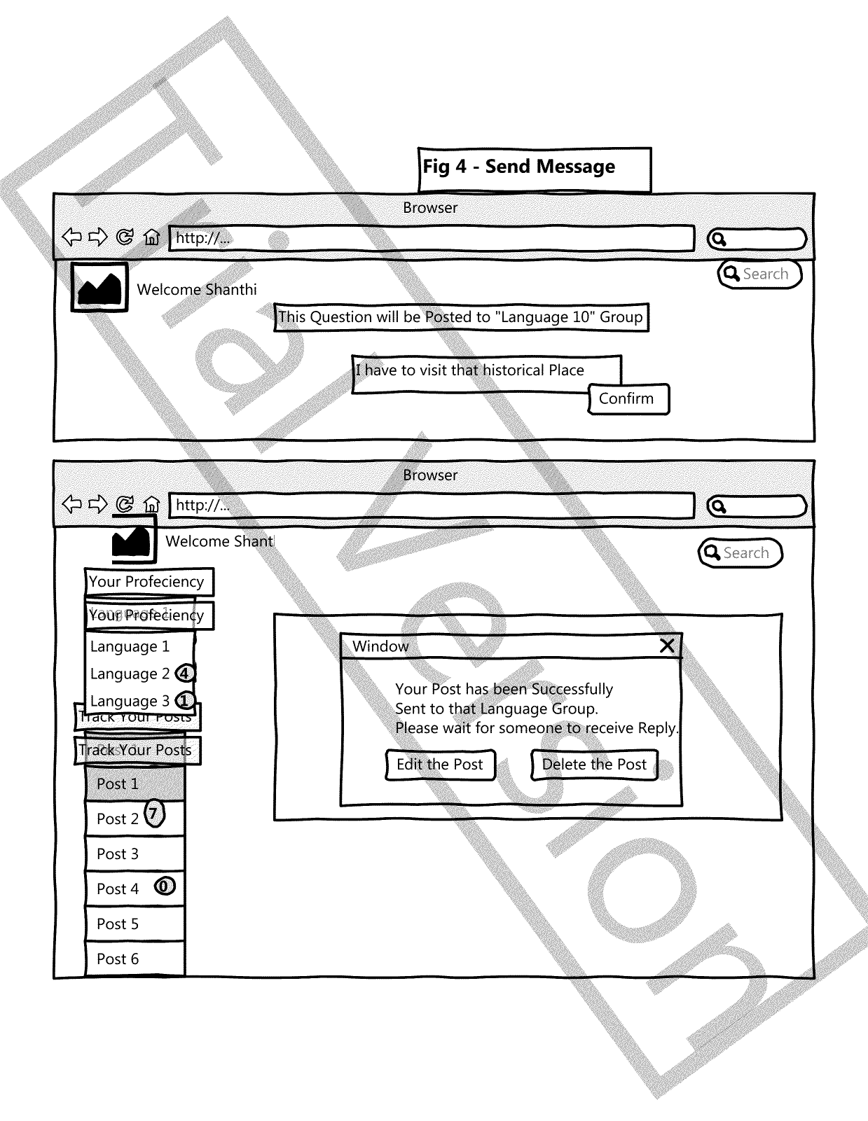

FIG. 4—Confirm Message and Send: The User is prompted with a message telling that this particular message would be submitted to this Language Group and wait for the User's Confirmation. If the User selects the ‘Confirm’ button, the message is sent to that Language Group and a Confirmation message is displayed.

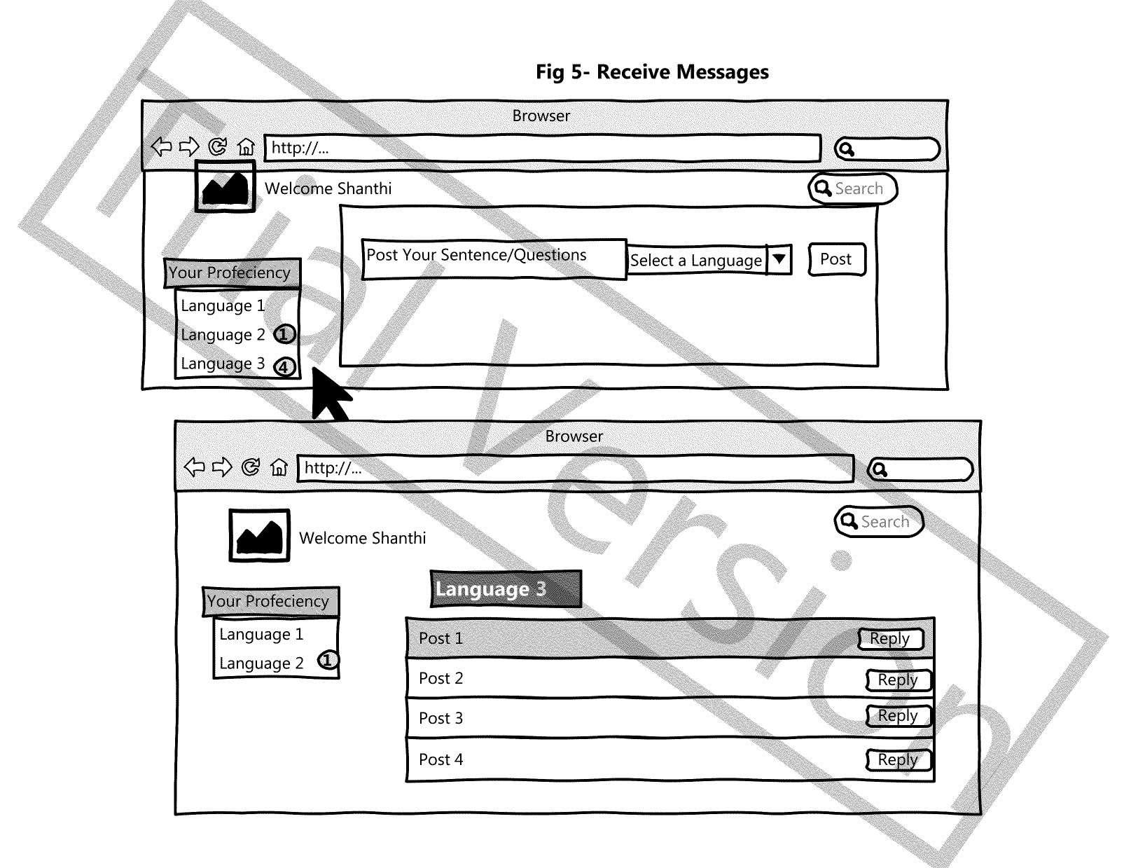

FIG. 5—Receive Messages: Only the Registered Users who had registered for their Proficient Languages receive messages to be translated to help others by translating them and sending it to them. On their Proficiency Language List, they receive the number of Messages to be translated. Once they select that Number, all the questions under that are displayed. The User can delete any message if they don't want to translate them or send them the Reply with the translated message. The deleted messages by the Registered User, drops in a bucket where it would be reassigned to another user who is also proficient in that Particular Language.

1. The Process/method of claim 1 is to send messages/pictures to other Language Group(s) and to receive/get the translated message(s) or picture(s) from Users who are proficient in that Language.

2. The Process/method of claim 2 is that Users must register with their preferred Language(s) that they are proficient with in order to help others by translating their message(s)/picture(s).

3. The Process/method of claim 3 is that an unregistered user can only submit their message/pictures to other Language Groups and receive the response for the same.

4. The Process/method of claim 4 is that a registered user can submit their messages/pictures as well as respond to others message/pictures based on their language proficiency opted for.

5. The Process/method of claim 5 is that a User can register up to 3 languages that they are proficient (speak, read or write) with.

6. The Process/method of claim 6 is that an User can edit their language preference anytime they are logged in.

7. The Process/method of claim 7 is that an User can delete their Language Preference anytime they are logged in.

8. The Process/method of claim 8 is that an User might get 10-15 messages/pictures to respond on a given day based on their language proficiency they have opted for.

9. The Process/method of claim 9 is that a message/picture can be sent and made available for other users in their queue with similar Language Proficiency so that the person who had sent receives response from at least one of them.

10. The Process/method of claim 10 is that there can be multiple response for a single message/picture that needs to be translated.

11. The Process/method of claim 11 is that the ability to track the messages/pictures sent by the User to other Language Groups for Translation.

12. The Process/method of claim 12 is that the ability to track the messages/pictures received after they were Translated and sent by other Language Groups.

13. The Process/method of claim 13 is that a Translated response received can be either deleted or saved by the User.

14. The Process/method of claim 14 is that a user messages/pictures sent to a Language Group for Translation can be edited or deleted by the User.
